(19) United States
(12) Patent Application Publication
(10) Pub. No.: US 2016/0245095 A1
(43) Pub. Date: Aug. 25, 2016

(54) TURBINE ROTOR BLADE

(71) Applicant: General Electric Company, Schenectady, NY (US)

(72) Inventors: Rohit Chouhan, Bangalore (IN); Sumeet Soni, Bangalore (IN); Jason Adam Neville, Greenville, SC (US)

(21) Appl. No.: 14/631,409

(22) Filed: Feb. 25, 2015

(51) Int. Cl. F01D 5/18; F02C 3/04; F02C 7/18; F01D 5/14

(52) U.S. Cl. CPC F01D 5/187; F01D 5/141; F02C 3/04; F02C 7/18; F05D 2220/32; F05D 2240/307; F05D 2260/20; F05D 2240/35

(57) ABSTRACT

A turbine rotor blade includes a tip portion having a pressure tip wall and a suction tip wall, a tip leading edge and a tip trailing edge, wherein the pressure tip wall and the suction tip wall define a trailing edge tip thickness. Also included is a squealer cavity at least partially defined by the pressure tip wall and the suction tip wall, the squealer cavity including a trench extending fully to the tip trailing edge to form an open flow path out of the tip trailing edge. Further included is a suction side wall and a pressure side wall extending from a root portion of the turbine rotor blade to the tip portion, wherein the suction side wall and the pressure side wall define a trailing edge blade thickness, the trailing edge tip thickness being greater than the trailing edge blade thickness.

### BACKGROUND OF THE INVENTION

The subject matter disclosed herein relates to turbine systems and, more particularly, to a turbine rotor blade with enhanced cooling and reduced tip leakage losses.

In a gas turbine engine, air pressurized in a compressor is used to combust a fuel in a combustor to generate a flow of hot combustion gases, whereupon such gases flow downstream through one or more turbines so that energy can be extracted therefrom. In accordance with such a turbine, generally, rows of circumferentially spaced turbine rotor blades extend radially outwardly from a supporting rotor disk. Each blade typically includes a dovetail that permits assembly and disassembly of the blade in a corresponding dovetail slot in the rotor disk, as well as an airfoil that extends radially outwardly from the dovetail and interacts with the flow of the working fluid through the engine.

The airfoil has a generally concave pressure side and generally convex suction side extending axially between corresponding leading and trailing edges and radially between a root and a tip. It will be understood that the blade tip is spaced closely to a radially outer turbine shroud for minimizing leakage therebetween of the combustion gases flowing downstream between the turbine blades. Improved efficiency of the engine is obtained by minimizing the tip clearance or gap such that leakage is prevented, but this strategy is limited somewhat by the different thermal and mechanical expansion and contraction rates between the rotor blades and the turbine shroud and the motivation to avoid an undesirable scenario of having the tip rub against the shroud during operation.

In addition, because turbine blades are bathed in hot combustion gases, effective cooling is required for ensuring a useful part life. Typically, the blade airfoils are hollow and disposed in flow communication with the compressor so that a portion of pressurized air bled therefrom is received for use in cooling the airfoils. Airfoil cooling is quite sophisticated and may be employed using various forms of internal cooling channels and features, as well as cooling holes through the outer walls of the airfoil for discharging the cooling air. Nevertheless, airfoil tips are particularly difficult to cool since they are located directly adjacent to the turbine shroud and are heated by the hot combustion gases that flow through the tip gap. Accordingly, a portion of the air channeled inside the airfoil of the blade is typically discharged through the tip for the cooling thereof.

Tip portions of blades often include a pocket that the cooling air is discharged to, but the cooling air is typically forced to be expelled radially outwardly over the top of the pocket walls, thereby not utilizing the high pressure cooling flow to contribute to produce work/torque.

### BRIEF DESCRIPTION OF THE INVENTION

According to one aspect of the invention, a turbine rotor blade includes a tip portion having a pressure tip wall and a suction tip wall, a tip leading edge and a tip trailing edge, wherein the pressure tip wall and the suction tip wall define a trailing edge tip thickness. Also included is a squealer cavity at least partially defined by the pressure tip wall and the suction tip wall, the squealer cavity including a trench extending fully to the tip trailing edge to form an open flow path out of the tip trailing edge. Further included is a suction side wall and a pressure side wall extending from a root portion of the turbine rotor blade to the tip portion, wherein the suction side wall and the pressure side wall define a trailing edge blade thickness that is less than the trailing edge tip thickness.

According to another aspect of the invention, a turbine section of a turbine system includes a plurality of turbine rotor blades forming a plurality of turbine stages, wherein each of the plurality of turbine rotor blades includes a leading edge a trailing edge, a suction side wall and a pressure side wall, wherein the suction side wall and the pressure side wall define a trailing edge blade thickness. Also included is a tip portion of at least one of the plurality of turbine rotor blades having a pressure tip wall and a suction tip wall, a tip leading edge and a tip trailing edge, wherein the pressure tip wall and the suction tip wall proximate the tip trailing edge define a trailing edge blade thickness, the trailing edge tip thickness being greater than the trailing edge blade thickness.

According to yet another aspect of the invention, a gas turbine engine includes a compressor section, a combustion section, and a turbine section. The turbine section includes a plurality of turbine rotor blades forming a plurality of turbine stages, wherein each of the plurality of turbine rotor blades includes a leading edge a trailing edge, a suction side wall and a pressure side wall, wherein the suction side wall and the pressure side wall define a trailing edge blade thickness. The turbine section also includes a tip portion of at least one of the plurality of turbine rotor blades having a pressure tip wall and a suction tip wall, a tip leading edge and a tip trailing edge, wherein the pressure tip wall and the suction tip wall proximate the tip trailing edge define a trailing edge tip thickness that is greater than the trailing edge blade thickness.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic illustration of a gas turbine engine;

FIG. 2 is a perspective view of a turbine rotor blade of the gas turbine engine;

FIG. 3 is a perspective view of a trailing edge of the turbine rotor blade;

FIG. 4 is a sectional view of the trailing edge of the turbine rotor blade; and

FIG. 5 is a perspective view of the trailing edge of the turbine rotor blade illustrating another aspect of the invention.

The detailed description explains embodiments of the invention, together with advantages and features, by way of example with reference to the drawings.

### DETAILED DESCRIPTION OF THE INVENTION

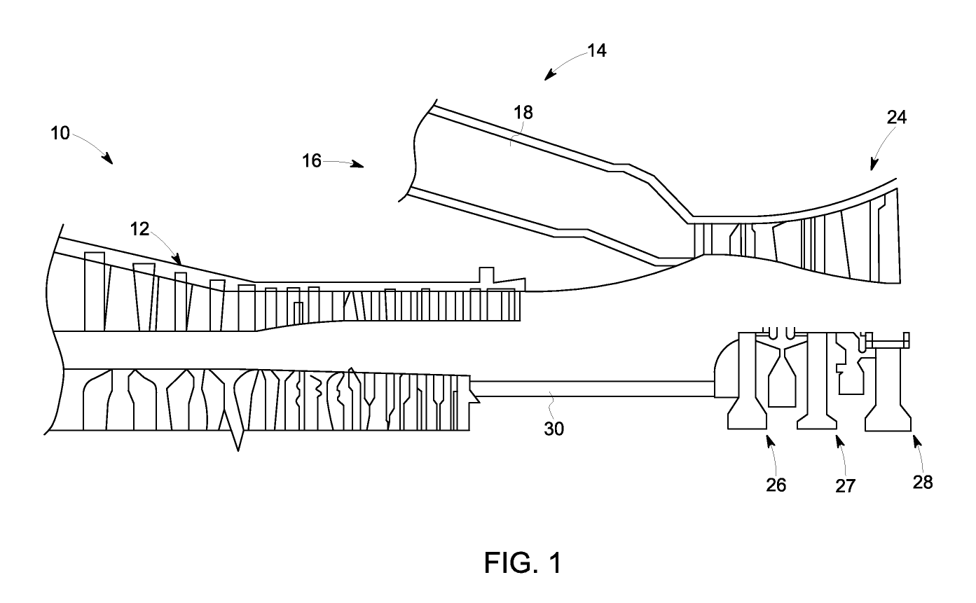

Referring to FIG. 1, a turbine system, such as a gas turbine engine 10, constructed in accordance with an exemplary embodiment of the present invention is schematically illustrated. The gas turbine engine 10 includes a compressor section 12 and a plurality of combustor assemblies arranged in a can annular array, one of which is indicated at 14. The combustor assembly is configured to receive fuel from a fuel supply (not illustrated) and a compressed air from the compressor section 12. The fuel and compressed air are passed into a combustor chamber 18 and ignited to form a high temperature, high pressure combustion product or air stream that is used to drive a turbine 24. The turbine 24 includes a plurality of stages 26-28 that are operationally connected to the compressor 12 through a compressor/turbine shaft 30 (also referred to as a rotor).

In operation, air flows into the compressor 12 and is compressed into a high pressure gas. The high pressure gas is supplied to the combustor assembly 14 and mixed with fuel, for example natural gas, fuel oil, process gas and/or synthetic gas (syngas), in the combustor chamber 18. The fuel/air or combustible mixture ignites to form a high pressure, high temperature combustion gas stream, which is channeled to the turbine 24 and converted from thermal energy to mechanical, rotational energy.

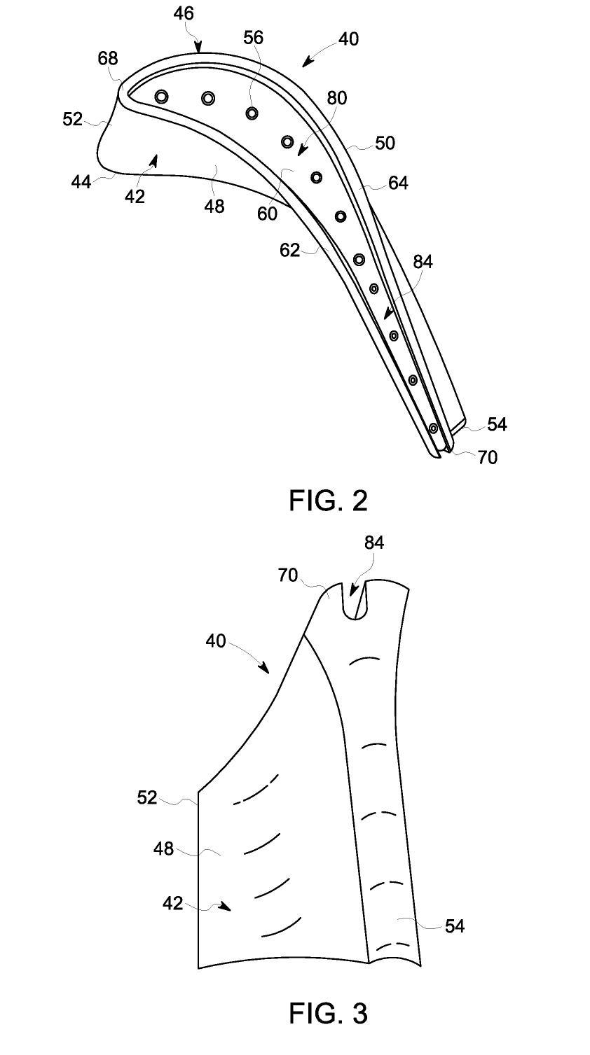

Referring now to FIGS. 2, 3 and 5, with continued reference to FIG. 1, a perspective view of a portion of a turbine rotor blade 40 (also referred to as a “turbine bucket,” “turbine blade airfoil” or the like) is illustrated. It is to be appreciated that the turbine rotor blade 40 may be located in any stage of the turbine 24. In one embodiment, the turbine rotor blade 40 is located within the illustrated first stage (i.e., stage 26) of the turbine 24. Although only three stages are illustrated, it is to be appreciated that more or less stages may be present. In any event, the turbine rotor blade 40 includes a main body portion 42 that extends from a root portion 44 to a tip portion 46. The main body portion 42 of the turbine rotor blade 40 includes a pressure side wall 48 and a suction side wall 50, where the geometry of the turbine rotor blade 40 is configured to provide rotational force for the turbine 24 as fluid flows over the turbine rotor blade 40. As depicted, the suction side wall 50 is convex-shaped and the pressure side wall 48 is concave-shaped. The main body portion 42 further includes a leading edge 52 and a trailing edge 54. Although the following discussion primarily focuses on gas turbines, the concepts discussed are not limited to gas turbine engines and may be applied to any rotary machine employing turbine blades.

The pressure side wall 48 and the suction side wall 50 are spaced apart in the circumferential direction over the entire radial span of the turbine rotor blade 40 to define at least one internal flow chamber or channel for channeling cooling air through the turbine rotor blade 40 for cooling thereof. Cooling air is typically bled from the compressor section 12 in any conventional manner. The inside of the turbine airfoil blade 40 may have any configuration including, for example, serpentine flow channels with various turbulators therein for enhancing cooling air effectiveness, with cooling air being discharged through at least one, but typically a plurality of outlet holes 56 located at the tip portion 46 of the turbine rotor blade 40 and, more particularly, proximate a squealer cavity 80 that will be described in detail below in conjunction with the tip portion 46.

The tip portion 46 includes a tip plate 60 disposed atop the radially outer ends of the pressure side wall 48 and the suction side wall 50, where the tip plate 60 bounds the internal cooling cavities. The tip plate 60 may be integral to the turbine rotor blade 40 or may be welded into place. A pressure tip wall 62 and a suction tip wall 64 may be formed on the tip plate 60. Generally, the pressure tip wall 62 extends radially outwardly from the tip plate 60 and extends axially from a tip leading edge 68 to a tip trailing edge 70. Generally, the pressure tip wall 62 forms an angle with the tip plate 60 that is approximately 90°, though this may vary. The path of pressure tip wall 62 is adjacent to or near the termination of the pressure side wall 48 (i.e., at or near the periphery of the tip plate 60 along the pressure side wall 48).

Similarly, the suction tip wall 64 generally extends radially outwardly from the tip plate 60 and extends axially from the tip leading edge 68 to the tip trailing edge 70. The path of the suction tip wall 64 is adjacent to or near the termination of the suction side wall 50 (i.e., at or near the periphery of the tip plate 60 along the suction side wall 50). The height and width of the pressure tip wall 62 and/or the suction tip wall 64 may be varied depending on best performance and the size of the overall turbine assembly. As shown, the pressure tip wall 62 and/or the suction tip wall 64 may be approximately rectangular in shape, although other shapes are also possible.

The pressure tip wall 62 and the suction tip wall 64 generally form what is referred to herein as the squealer cavity 80. The squealer cavity 80 may include any radially inward extending depression or cavity formed on or within the tip portion 46. Generally, the squealer cavity 80 has a similar shape or form as the turbine rotor blade 40, though other shapes are possible, and is typically bound by the pressure tip wall 62, the suction tip wall 64, and an inner radial floor, which herein has been described as the tip plate 60.

As best illustrated in FIGS. 3 and 5, the tip portion 46 of the turbine rotor blade 40 includes at least one winglet 82 located proximate the tip trailing edge 70. In some embodiments, the at least one winglet 82 is located immediately adjacent the extreme location of the tip trailing edge 70. The phrase “at least one” is employed to describe the at least one winglet 82 based on the fact that in one embodiment the at least one winglet 82 is an outwardly flared region of the tip pressure wall 62 at the tip trailing edge 70. In another embodiment, the at least one winglet 82 is an outwardly flared region of the tip suction wall 64 at the tip trailing edge 70. In yet another embodiment, both the tip pressure wall 62 and the tip suction wall 64 are flared outwardly at the tip trailing edge 70 to form the at least one winglet 82.

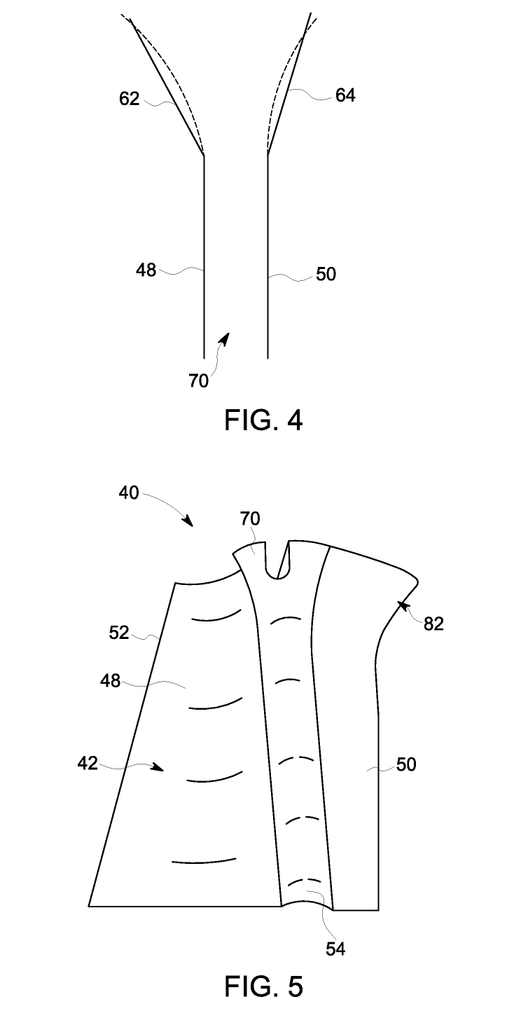

A local increase in thickness along the trailing edge is provided, including the tip trailing edge 70 and possibly the trailing edge 54 of the main body portion 42 of the blade. The increase in thickness is gradual and widens in a radially outward direction of the turbine rotor blade 40. The increase may be made in a linear manner or in a curve of higher order (FIG. 4). The term “local increase” refers to the thickening of the trailing edge at radial location that is from a radial point of the trailing edge that is at a radial length at least about 80% of the blade. In other words, the thickening of the trailing edge begins to occur at a radial length of the blade that is at least about 80% of the trailing edge length away from the root of the blade. The trailing edge thickness increase may occur from about 80% of the radial length of the trailing edge to an outermost location corresponding to about 100% of the radial length of the trailing edge. In another embodiment, the thickening occurs from about 95% to 100% of the radial length of the trailing edge. The entire radial length of the trailing edge of the blade has a constant width at all regions prior to initial widening of the trailing edge. Illustrated in conjunction with the examples provided above, the trailing edge thickness remains constant from the root portion to about 80% or about 95% of the radial length of the trailing edge. The embodiments provided above are merely examples and it is to be appreciated that the initial widening location may vary depending upon the application.

The widened region of the trailing edge a trench 84 that is part of the squealer cavity 80, the advantages of which will be described in detail below. Inclusion of the at least one winglet 82 provides additional benefits. One benefit associated with the outwardly flared region, particularly in embodiments associated with the tip suction wall 64, the tip region leakage is reduced, thereby improving efficiency of the turbine section 24. This is due to weakening of tip leakage vortices proximate the tip portion 46 of the turbine rotor blade 40, which tends to inhibit flow at this region. Another benefit associated with the at least one winglet 82 relates to further thickening of the tip trailing edge 70. This enhanced thickening of the tip trailing edge 70 further accommodates the trench 84 that is part of the squealer cavity 80.

The trench 84 comprises a depression, groove, notch, trench, or similar formation that is positioned at an aft end of the squealer cavity 80 and extends fully to the tip trailing edge 70 of the tip portion 46, thereby forming a flow path for a cooling flow that opens directly out of the tip trailing edge 70 into a main flow path of the turbine section 24. The trench 84 may comprise several different shapes, sizes, alignments, and configurations. For example, as illustrated in FIG. 2, the trench 84 may extend along a substantially linear path. Generally, the longitudinal axis of the trench 84 is aligned in an approximate downstream direction. In some embodiments, the trench 84 is slightly arcuate in nature. It is contemplated that the trench 84 is located closer to the pressure tip wall 62 than the suction tip wall 64. Because cooling air that flow out of the trench 84 generally moves toward the suction tip wall 64, this configuration may allow escaping cooling air to flow over a greater tip surface and thereby have a greater cooling effect than if the trailing edge trench 72 were located closer to the suction tip wall 64. However, it is contemplated that the trench 84 is located closer to suction tip wall 64 than the pressure tip wall 62. In addition, the trench 84, wherever located, may have a curved, linear, zig-zagging or serpentine path. In some embodiments, the trench 84 may be treated with a coating, such as a bond coat or other type of high-temperature coating. In some embodiments, the coating may be a corrosion inhibitor with high aluminum content, such as an alumide coating. An alumide coating is well-suited for the interior of the trench 84 because this location is relatively sheltered from rubbing against adjacent parts. Alumide coatings are highly effective against corrosion, but tend to wear quickly and, thus, normally would not be used on the blade tip area of a turbine blade. The trench 84 provides a cost-effective opportunity for its usage in this area.

The cross-sectional profile of the trench 84 may be approximately semi-elliptical in nature. Alternatively, though not depicted in the figures, the profile of the trench 84 may be rectangular, semi-circular, triangular, trapezoidal, “V” shaped, “U” shaped and other similar shapes, as well as other combinations of profiles and filet radii. The edge formed between the top of the pressure tip wall 62, the suction tip wall 64 and the radially aligned walls of the trench 84 may be sharp (i.e., a 90 degree corner) or, in some cases, more rounded in nature.

The depth of the trench 84 may be substantially constant as it extends toward the tip trailing edge 70. Note that as used herein, the depth of the trench 84 is meant to refer to the maximum radial height of the trench 84 at a given location on its path. Thus, in the case of a semi-elliptical profile, the depth of the trench 84 occurs at the inward apex of the elliptical shape. In other embodiments, the depth of the trench 84 may vary to become less or more deep relative to the upstream, originating location of the trench 84. Similarly, the width of the trench 84 may be constant or vary along an entire length of the trench 84.

Regardless of the precise configuration of the trench 84, the localized thickened tip trailing edge 70 and the at least one winglet 82 facilitates a widening of the trench 84 at the tip trailing edge 70. In particular, a space between outer portions of the pressure tip wall 62 and the suction tip wall 64 at the tip trailing edge 70 is defined and is referred to as a trailing edge tip thickness. Similarly, a space between outer portions of the pressure side wall 48 and the suction side wall 50 at the trailing edge 54 of the main body portion 42 is defined and is referred to as a trailing edge blade thickness. The trailing edge tip thickness is greater than the trailing edge blade thickness. In other words, a localized thickening of the trailing edge region of the overall turbine rotor blade 40. In one embodiment, the trailing edge tip thickness is about 1.1 times to about 3.0 times the thickness of the trailing edge blade thickness. In another embodiment, the trailing edge tip thickness is about 1.5 times to about 2.5 times the thickness of the trailing edge blade thickness. In yet another embodiment, the trailing edge tip thickness is about 1.95 times to about 2.05 times the thickness of the trailing edge blade thickness. The preceding examples are merely illustrative of the fact that the trailing edge tip thickness is greater than the trailing edge blade thickness. The local increase in the thickness at the tip of the blade adds extra local mass at the tip trailing edge portion. Addition of this mass on the tip will change the frequency of the blade in a favorable direction which assists in meeting aerodynamics requirements of the blade. The local increase in thickness targets a local mass addition at the trailing edge portion of the tip. Due to the location's high kinetic energy, it is very sensitive to changes in mass and stiffness, which will change the airfoil's mode shapes and frequencies. These changes in mode shapes and frequencies are used to the blade's advantage to avoid aeromechanic drivers and to meet design requirements.

As noted above, the squealer cavity 80 includes the plurality of outlet holes 56 for expulsion of cooling flow. The plurality of outlet holes 56 is also present within the trench 84 for the provision of cooling air to this region of the squealer cavity 80 to keep the surrounding surface area of the tip portion 46 cool by convecting away heat and insulating the part from the extreme temperatures of the working fluid. More particularly, the coolant may better cool the tip portion 46 proximate the tip trailing edge 70. As shown, the trench cooling apertures may be regularly spaced through the trench 84 and positioned on the floor of the trench 84, i.e., near the deepest portion of the trench 84.

Advantageously, the embodiments described above decrease the tip leakage flow and weaken the tip leakage vortex, thereby reducing losses that directly impact overall turbine system efficiency. Increasing the trailing edge thickness at the tip portion 46, in combination with the winglet 82, allows higher width of the trench 84 at the squealer cavity 80. A wider trench facilitates a wider space for the cooling flow to escape from the trench opening at the immediate tip trailing edge 70, in contrast to closed squealer cavities that require the cooling flow to escape from the radially outward portion of the squealer cavity 80. By increasing the trailing edge thickness only proximate the tip portion, an aerodynamic benefit is achieved by accommodating the wider trench. In particular, the trench 84 better utilizes the cooling flow to extract work from the cooling flow as the cooling flow imparts a circumferential force along the trench wall as it flows toward the trailing edge. Rather than wasting the cooling flow by simply expelling it from the squealer cavity, the cooling flow assists in the rotation of the blade.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A turbine rotor blade comprising:
a tip portion having a pressure tip wall and a suction tip wall, a tip leading edge and a tip trailing edge, wherein the pressure tip wall and the suction tip wall define a trailing edge tip thickness;
a squealer cavity at least partially defined by the pressure tip wall and the suction tip wall, the squealer cavity including a trench extending fully to the tip trailing edge to form an open flow path out of the tip trailing edge; and
a suction side wall and a pressure side wall extending from a root portion of the turbine rotor blade to the tip portion, wherein the suction side wall and the pressure side wall define a trailing edge blade thickness, wherein the trailing edge tip thickness that is greater than the trailing edge blade thickness.

2. The turbine rotor blade of claim 1, wherein the suction tip wall comprises a winglet proximate the tip trailing edge.

3. The turbine rotor blade of claim 1, wherein an overall trailing edge thickness of the turbine rotor blade is constant from a root portion to a radial length of the turbine rotor blade that is at least 80% of an overall length of the turbine rotor blade at the trailing edge, wherein the thickness of the trailing edge is gradually increased from a radial length of at least 80% of the overall length of the turbine rotor blade at the trailing edge to an outer tip location of the trailing edge.

4. The turbine rotor blade of claim 1, wherein the trailing edge tip thickness is 1.1 to 3.0 times the thickness of the trailing edge blade thickness.

5. The turbine rotor blade of claim 1, wherein the trailing edge tip thickness is 1.5 to 2.5 times the thickness of the trailing edge blade thickness.

6. The turbine rotor blade of claim 1, wherein the trailing edge tip thickness is about 1.95 to 2.05 times the thickness of the trailing edge blade thickness.

7. The turbine rotor blade of claim 1, further comprising a trench depth that is constant along an entire length of the trench.

8. The turbine rotor blade of claim 1, further comprising a plurality of cooling holes extending radially throughout the turbine rotor blade, the plurality of cooling holes having a plurality of corresponding outlet holes configured to expel a cooling flow proximate the squealer cavity.

9. A turbine section of a turbine system comprising:
a plurality of turbine rotor blades forming a plurality of turbine stages, wherein each of the plurality of turbine rotor blades includes a leading edge a trailing edge, a suction side wall and a pressure side wall, wherein the suction side wall and the pressure side wall define a trailing edge blade thickness; and
a tip portion of at least one of the plurality of turbine rotor blades having a pressure tip wall and a suction tip wall, a tip leading edge and a tip trailing edge, wherein the pressure tip wall and the suction tip wall proximate the tip trailing edge define a trailing edge tip thickness that is greater than the trailing edge blade thickness.

10. The turbine section of claim 9, further comprising a squealer cavity at least partially defined by the pressure tip wall and the suction tip wall, the squealer cavity including a trench extending fully to the trailing edge to form an open flow path out of the trailing edge.

11. The turbine section of claim 9, wherein the suction tip wall comprises a winglet proximate the tip trailing edge.

12. The turbine section of claim 9, wherein the pressure tip wall comprises a winglet proximate the tip trailing edge.

13. The turbine section of claim 9, wherein the pressure tip wall and the suction tip wall each comprise a winglet proximate the tip trailing edge.

14. The turbine section of claim 9, wherein the trailing edge tip thickness is 1.5 to 2.5 times the thickness of the trailing edge blade thickness.

15. The turbine section of claim 9, wherein the trailing edge tip thickness is about 1.95 to 2.05 times the thickness of the trailing edge blade thickness.

16. The turbine section of claim 10, further comprising a trench depth that is constant along an entire length of the trench.

17. The turbine section of claim 10, further comprising a plurality of cooling holes extending radially throughout the at least one turbine rotor blade, the plurality of cooling holes having a plurality of corresponding outlet holes configured to expel a cooling flow proximate the squealer cavity.

18. A gas turbine engine comprising:
a compressor section;
a combustion section; and
a turbine section comprising:
a plurality of turbine rotor blades forming a plurality of turbine stages, wherein each of the plurality of turbine rotor blades includes a leading edge a trailing edge, a suction side wall and a pressure side wall, wherein the suction side wall and the pressure side wall define a trailing edge blade thickness; and
a tip portion of at least one of the plurality of turbine rotor blades having a pressure tip wall and a suction tip wall, a tip leading edge and a tip trailing edge, wherein the pressure tip wall and the suction tip wall proximate the tip trailing edge define a trailing edge tip thickness that is greater than the trailing edge blade thickness.

19. The gas turbine engine of claim 18, further comprising a squealer cavity at least partially defined by the pressure tip wall and the suction tip wall, the squealer cavity including a trench extending fully to the trailing edge to form an open flow path out of the trailing edge.

20. The gas turbine engine of claim 18, wherein at least one of the suction tip wall and the pressure tip wall comprises a winglet proximate the tip trailing edge.
